(19) United States
(12) Patent Application Publication
(10) Pub. No.: US 2026/0017866 A1
(43) Pub. Date: Jan. 15, 2026

(54) ANIMATION PLAYING METHOD AND APPARATUS, AND ELECTRONIC DEVICE, AND COMPUTER-READABLE STORAGE MEDIA

(71) Applicant: HUIZHOU TCL MOBILE COMMUNICATION CO., LTD., Huizhou, Guangdong (CN)

(72) Inventors: Binhong WANG, Huizhou, Guangdong (CN); Tang DING, Huizhou, Guangdong (CN)

(73) Assignee: HUIZHOU TCL MOBILE COMMUNICATION CO., LTD., Huizhou, Guangdong (CN)

(21) Appl. No.: 18/881,308

(22) PCT Filed: Apr. 28, 2023
(86) PCT No.: PCT/CN2023/091844

§ 371 Date: Jan. 6, 2025

(30) Foreign Application Priority Data
Jul. 6, 2022 (CN) 202210797483.7

(51) Int. Cl. G06T 13/80; G06F 9/451

(52) U.S. Cl. CPC G06T 13/80; G06F 9/451

(57) ABSTRACT

Disclosed in the present application are an animation playing method and apparatus, and an electronic device and a computer-readable storage medium. The method in the present application comprises: if an exit instruction for a target starting animation is monitored, acquiring a playback progress of the target starting animation; playing an exit animation according to the playback progress or the target starting animation: and when the playback or the exit animation is completed, executing an interruption transaction, so as to display an interface before the playback or the target starting animation. In the present application, the degree or continuity between the playback of a starting animation and the playback of an exit animation can be improved.

This application claims the priority of Chinese Patent Application No. 2022107974837, entitled “Animation Playing Method and Apparatus, and Electronic Device, and Computer-Readable Storage Media”, filed on Jul. 6, 2022, the disclosure of which is incorporated herein by reference in its entirety.

### FIELD OF THE DISCLOSURE

The present disclosure relates to the field of animation technology, and more particularly, to an animation playback method, an apparatus, an electronic device, and a computer-readable storage media.

### BACKGROUND

With the development of science and technology, there are more and more applications running on electronic devices, and they are becoming more and more popular among users. When the user clicks on the icon of the application, the icon of the application will be enlarged and the interface of the application will be displayed. This process is called the playback of the startup animation, and the process of returning to the desktop from the interface of the application according to the exit instruction is called the playback of the exit animation.

However, if an exit instruction is received when the playback of the startup animation is not completed, the connection between the startup animation and the exit animation will not be smooth, and the phenomenon of stuttering will occur.

### Technical Problem

In other words, there is a technical issue of an unsmooth connection between the playback of the startup animation and the playback of the exit animation.

### Technical Solution

One objective of an embodiment of the present disclosure is to provide an animation playback method and device, which can solve the technical problem that the playback of the startup animation and the playback of the exit animation are not smooth.

According to an embodiment of the present disclosure, a method of playing animations is disclosed. The method comprises:
monitoring a target startup animation that is being played;
when the exit instruction for the target startup animation is detected, acquiring a playback progress of the target startup animation;
according to the playback progress of the target startup animation, playing an exit animation; and when the exit animation is completely played, executing an interruption to display an interface before the target startup animation is played.

Accordingly, the embodiment of the present disclosure provides an animation playback device comprising:
a monitor module, configured to monitor a target startup animation that is being played;
an acquisition module, configured to acquire a playback progress of the target startup animation, when an exit instruction for the target startup animation is detected;
a playback module, configured to play an exit animation, according to the playback progress of the target startup animation; and
an execution module, configured to execute an interruption to display an interface before the target startup animation is played, when the exit animation is completely played.

In addition, an embodiment of the present disclosure proposes an electronic device that includes a processor and a memory storing computer instructions executable by the processor to perform the method of playing animations provided in the embodiment of the present disclosure.

In addition, an embodiment of the present disclosure proposes a computer-readable storage medium storing computer instructions executable by a processor to perform the method of playing animations provided in the embodiment of the present disclosure.

In addition, an embodiment of the present disclosure provides a computer program product storing computer instructions executable by a processor to perform the method of playing animations provided in the embodiment of the present disclosure.

### Advantageous Effect

In an embodiment of the present disclosure, the target startup animation that is being played is monitored. When an exit instruction for the target startup animation is detected, the playback progress of the target startup animation is acquired. Then, according to the playback progress, the exit animation is played. When the exit animation playback is complete, an interruption is executed to display the interface before the playback of target startup animation.

That is, in an embodiment of the present disclosure, when the exit instruction of the target startup animation is detected, the exit animation is first played according to the playback progress of the target startup animation, so that the playback of the target startup animation and the playback of the exit animation are seamlessly connected, and then the interruption is executed when the exit animation playback is completed, so as to avoid that the interruption is executed first and then the exit animation is played, which results the unsmooth connection between the playback of the startup animation and the playback of the exit animation.

### BRIEF DESCRIPTION OF THE DRAWINGS

In order to more clearly illustrate the technical solutions in the embodiments of the present disclosure, the drawings required to be used in the description of the embodiments will be briefly introduced below, and it is obvious that the drawings described below are only some embodiments of the present disclosure, and for those skilled in the art, other drawings can be acquired according to these drawings without creative labor.

FIG. 1 is a diagram of the animation playback method according to an embodiment of the present disclosure.

FIG. 2 is a diagram of the registration process for the target startup animation according to an embodiment of the present disclosure.

FIG. 3 is a diagram of the interruption animation management class and the intermediate service according to an embodiment of the present disclosure.

FIG. 4 is a diagram of the target startup animation according to an embodiment of the present disclosure.

FIG. 5 is a diagram of another animation playback method according to an embodiment of the present disclosure.

FIG. 6 is a diagram of another animation playback method according to an embodiment of the present disclosure.

FIG. 7 is an interactive diagram of the interruption animation management class, the intermediate service, the animation playback process and the interruption according to an embodiment of the present disclosure.

FIG. 8 is a diagram of the deregistration process of the target startup animation according to an embodiment of the present disclosure.

FIG. 9 is a diagram of the deregistration process and the registration process of the target startup animation of the target startup animation according to an embodiment of the present disclosure.

FIG. 10 is a schematic diagram of an animation playback device according to an embodiment of the present disclosure.

FIG. 11 is a schematic diagram of an electronic device according to an embodiment of the present disclosure.

### EMBODIMENTS OF THE PRESENT INVENTION

The technical solutions in the embodiments of the present disclosure will be clearly and completely described below in conjunction with the accompanying drawings in the embodiments of the present disclosure, and it is obvious that the described embodiments are only part of the embodiments of the present disclosure, not all embodiments. Based on the embodiments in the present disclosure, all other embodiments acquired by a person skilled in the art without creative work fall within the scope of protection of the present disclosure.

An embodiment of the present disclosure provides an animation playback method, an apparatus, an electronic device, and a computer-readable storage media. The animation playback device can be integrated in the electronic device which can be a server, a terminal and other equipment.

The server can be an independent physical server, a server cluster or a distributed system composed of multiple physical servers, or a cloud server that provides cloud services, cloud databases, cloud computing, cloud functions, cloud storage, network services, cloud communications, middleware services, domain name services, security services, network acceleration services (Content Delivery Network, CDN), and basic cloud computing services such as big data and artificial intelligence platforms.

The terminal can be but is not limited to a smartphone, a tablet, a laptop, a desktop computer, a smart speaker, a smart watch, etc. The terminals and the server may be connected directly or indirectly by wired or wireless communication, and the present disclosure is not limited herein.

In addition, “plurality” in the embodiment of the present disclosure refers to two or more embodiments. The words “first” and “second” in the embodiment of the present disclosure are used to distinguish descriptions and cannot be understood as implying relative importance.

Each of them is explained in detail below. It should be noted that the following embodiments are not used as a limitation on the preferred order of embodiments.

In this embodiment, it will be described from the perspective of an animation playback device, and in order to facilitate the description of the animation playback method of the present disclosure, the following will be described in detail with the animation playback device integrated in the terminal, that is, the terminal will be used as the execution subject to be detailed.

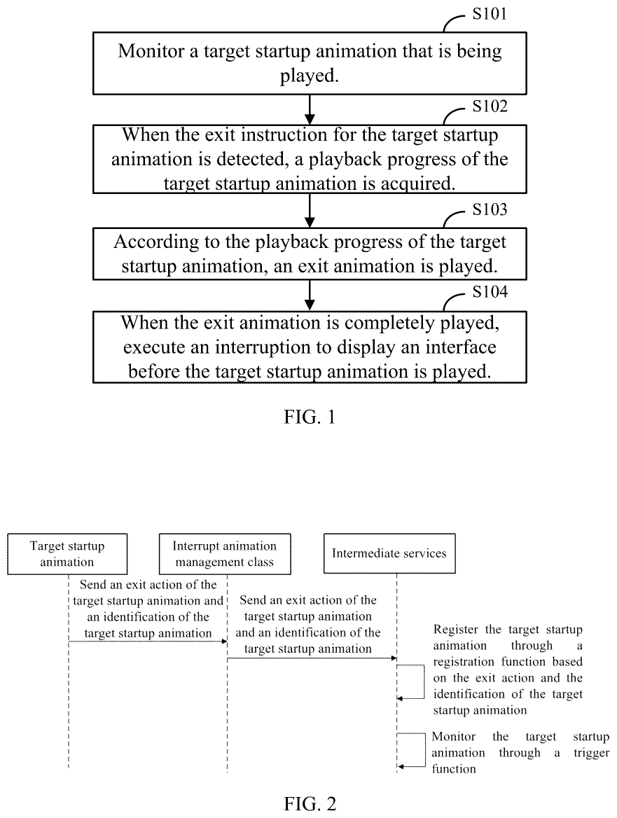

Please refer to FIG. 1. FIG. 1 is a diagram of the animation playback method according to an embodiment of the present disclosure. The animation playback method comprises step S101-S104.

At Step S101, monitor a target startup animation that is being played.

The startup animation can be a dynamic display of the screen of the terminal where the client is located during the client startup process. For example, when the client is an application, the terminal, in response to the triggering operation of the application icon, first dynamically displays the application icon, and then dynamically displays the application interface, until the application interface covers the terminal screen, then the dynamic display of the application icon and the interface screen form a startup animation.

The client can be small applications, web pages, application programs, and/or terminal booting programs. As to the type of client, the user can select it according to the actual situation, and thus this is not a limitation in this embodiment.

After the terminal acquires the client, the terminal can firstly register the target startup animation of the client to monitor the target startup animation when it detects that the target startup animation is being played. Alternatively, the terminal can register the target startup animation when it is playing. At this time, the step of monitoring the target startup animation that is playing comprises:
detecting the target startup animation; and
when the target startup animation is detected to be being played, registering the target startup animation to monitor the target startup animation.

In some embodiments, the step of “when it detects that the target startup animation is playing, registering the target startup animation to monitor the target startup animation” comprises:
when the target startup animation is detected to be being playing, acquiring the target startup animation by an interruption animation management class; wherein the interruption animation management class comprises a calling interface of an intermediate service;
through the calling interface, calling a registration function in the intermediate service to register the target startup animation; and
when registering the target startup animation is successful, calling a trigger function in the intermediate services through the calling interface to monitor the target startup animation.

In this embodiment, the intermediate service can be a bind service, and the registration function and the trigger function are located in the intermediate service, but the terminal does not have the function of directly calling the intermediate service. Therefore, the interruption animation management class is arranged. The interruption animation management class comprises the calling interface of the intermediate service. In this way, the registration function and the trigger function of the intermediate service are called through the calling interface of the interruption animation management class to realize the monitor of the target startup animation.

The step of acquiring the target startup animation through the interruption animation management class can refer to acquiring the identifier of the target startup animation and the exit action of the target startup animation through the interruption animation management class.

Please refer to FIG. 2. FIG. 2 is a diagram of the registration process for the target startup animation according to an embodiment of the present disclosure. As shown in FIG. 2, when the target startup animation is detected to be being played, the terminal calls the registration function (addBreakTarget) of the intermediate service (BreakAnimManagerService) through the call interface (getService) in the interruption animation management class (BreakAnimManager), and registers the target startup animation according to the exit action (int event) of the target startup animation and the identifier (IBreakableTarget) of the target startup animation. For example, the step of using the registration function in the intermediate service to register the target startup animation can be: void addBreakTarget (int event, IBreakableTarget target).

That is, the exit action of the target startup animation and the identifier of the target startup animation are sent to the interruption animation management class, and the terminal sends the exit animation of the target startup animation and the identifier of the target startup animation to the intermediate service through the call interface in the interruption animation management class, and finally the terminal uses the registration function in the intermediate service to register the target startup animation.

After the target startup animation is registered, the terminal uses the trigger function (breakAnim) in the intermediate service to monitor the target startup animation.

Since the registration and monitoring of the target startup animation are realized by the interruption animation management class and the intermediate service, when the target startup animation is detected to be being played, before acquiring the target startup animation through the interruption animation management class, the method further comprises:
acquiring the registration function and the trigger function, and creating the intermediate service according to the registration function and the trigger function; and
according to the calling interface of the intermediate service, creating the interruption animation management class.

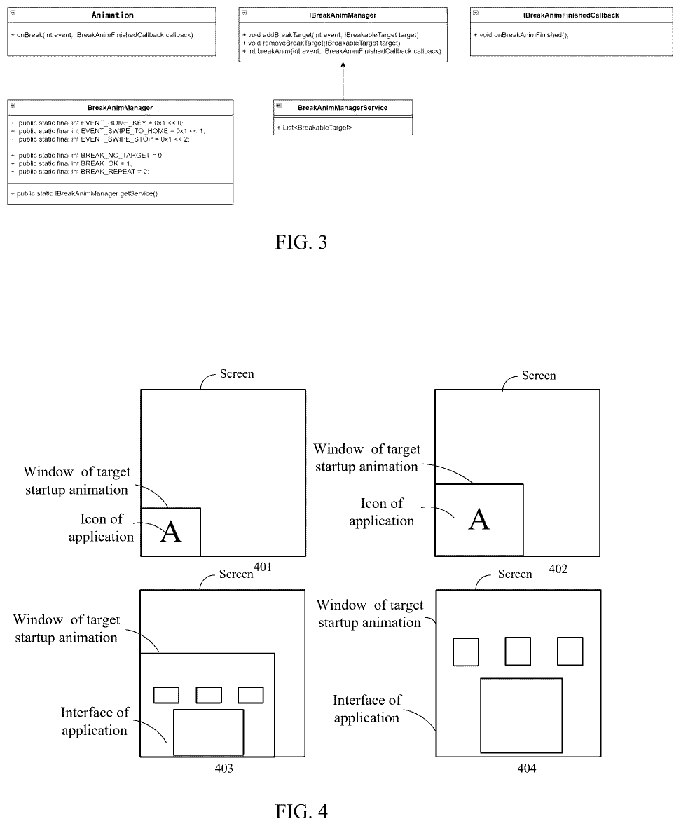

For example, the interruption animation management class and the intermediate service could be understood as shown in FIG. 3. “Animation” represents the animation playback process corresponding to the target startup animation.

It is understood that when the client is an application program, the interruption animation management class can be in the form of a software development kit (SDK) to be inserted to into the application program.

At Step S102, when the exit instruction for the target startup animation is detected, a playback progress of the target startup animation is acquired.

When the terminal detects an exit instruction for the target startup animation, the terminal acquires the playback progress of the target startup animation. The playback progress of the target startup animation could be a frame number of the target startup animation that is being played. The playback progress of the target startup animation could be a size of a window corresponding to the target startup animation. For example, when the size of the window corresponding to the target startup animation is 70% (that is, the window corresponding to the target startup animation occupies 70% of the screen) and the exit instruction of the target startup animation is detected, the playback progress of the target startup animation is 70%.

At step S103, according to the playback progress of the target startup animation, an exit animation is played.

In order to avoid jitters, the terminal can play the exit animation according to the playback progress of the target startup animation, so that the connection between the playback of the exit animation and the playback of the target startup animation is smoother.

When the playback progress of the target startup animation is 70%, the exit animation also starts playing from 70%.

Optionally, the exit animation and target startup animation can be of the same type of animation, or they can be of different types of animations. The exit animation and the target startup animation can be the same type of animation, which means that the content of the exit animation is the same as the content of the target startup animation. When the exit animation and the target startup animation are different types of animations, this means that the content of the exit animation is different from the content of the target startup animation.

It should be noted that when the client is a small program or an application program, if the content of the exit animation is the same as that of the target startup animation, this means that the content corresponding to the size of the window corresponding to the target startup animation and the size of the window corresponding to the exit animation are the same. If the content of the exit animation is different from the content of the target startup animation, the size of the window corresponding to the target startup animation is different from the size of the window corresponding to the exit animation.

As shown in FIG. 4, in the process that the size of the window corresponding to the target startup animation is 0-30%, the icon of the application program is dynamically displayed in the window corresponding to the target startup animation. At this time, the target startup animation is a screen of the application icon that is dynamically displayed. The picture 401 in FIG. 4 shows the screen of the terminal when the size of the window corresponding to the target startup animation is 15%, and the picture 402 in FIG. 4 shows the screen of the terminal when the size of the window corresponding to the target startup animation is 30%.

When the size of the window corresponding to the target startup animation is 31%-100%, the interface of the application program is dynamically displayed in the window corresponding to the target startup animation. The picture 403 in FIG. 4 shows the screen of the terminal when the size of the window corresponding to the target startup animation is 70%. The picture 404 in FIG. 4 shows the screen of the terminal when the size of the window corresponding to the target startup animation is 100%. At this time, the screen displayed by the terminal is covered with the window corresponding to the target startup animation. That is, the interface of the application program covers the entire screen.

On the condition that the interface of the application program is dynamically displayed in the window of the exit animation when the size of the window of the exit animation is 100%-31%, and the icon of the application program is also dynamically displayed in the window of the exit animation when the size of the window of the exit animation is 30%-0, the content of the exit animation is the same as the content of the target startup animation.

On the condition that the interface of the application is dynamically displayed in the window of the exit animation during the window of the exit animation is 100%-61%, and the application icon is dynamically displayed in the window of the exit animation when the size of the window of the exit animation is 60%-0%, the content of the exit animation is not the same as the content of the target startup animation.

When the exit animation and the target startup animation are of the same type of animation, the step of playing the exit animation according to the playback progress of the target startup animation comprises:
according to the playback progress of the target startup animation, playing back the target startup animation to play the exit animation.

Since the exit animation and the target startup animation are of the same type of animation, the target startup animation can be directly played back according to the playback progress of the target startup animation, so that the exit animation can be played.

The target startup animation is a startup animation of the application program. The target startup animation starts to play from 0%, and when the playback progress of the target startup animation is 70%, the startup animation is played back from 70% when the exit instruction is received.

When the exit animation and the target startup animation are different types of animations, the step of playing the exit animation according to the playback progress of the target startup animation comprises:
acquiring the exit animation;
determining a starting playback position of the exit animation according to the playback progress of the target start-up animation; and
playing the exit animation from the starting playback position.

The target startup animation is the startup animation of the application program. When the playback progress of the target startup animation is 70%, the startup playback position of the exit animation is 70%. That is, the size of the window corresponding to the exit animation is 70% of the screen.

In this embodiment, the exit animation and the target startup animation are different types of animations, so that in the process of client's startup and exit, different animations are played, so that the user can have a better user experience.

The exit animation can be the corresponding exit animation of the target startup animation. The exit animation and the target startup animation can first establish an association relationship, and then the terminal can get the exit animation corresponding to the target startup animation from the association relationship. The target startup animation and the exit animation can be associated with the client respectively. The terminal first determines the client corresponding to the target startup animation, and then finds the exit animation corresponding to the client corresponding to the target startup animation.

In some embodiments, the exit instruction comprises an exit action. The step of playing the exit animation according to the playback progress of the target startup animation comprises:
determining the exit animation corresponding to the exit action; and
playing the exit animation corresponding to the exit action according to the playback progress of the target startup animation.

In this embodiment, there are different exit actions. One exit action can correspond to an exit animation, thereby enriching the diversity of exit animations and improving the user experience.

The exit action can include triggering the Home button, swiping up, swiping up, swiping left, and swiping right.

In other embodiments, the method further comprises following steps before acquiring the target startup animation:
acquiring an animation playback instruction; and
activating an animation playback process according to the animation playback instruction to play the target startup animation, and the animation playback process comprises a playback code for the target startup animation and a playback code for the exit animation; and
wherein the step of playing an exit animation according to the playback progress of the target startup animation comprises:
playing an exit animation through the animation playback process according to the playback progress of the target startup animation

When the animation is played, the initiation should be firstly performed to load the animation resource. For example, when the target startup animation is the startup animation of the application program, initialization should be performed to load the application icon, the application interface, and the application window. When the playback code for the target startup animation and the playback code for the exit animation belong to different processes, the playback of the exit animation needs to be initialized again when the exit animation is played. Here, loading the animation resource slows down the playback of the exit animation.

In this embodiment, the playback code of the target startup animation and the playback code of the exit animation are in the same process. Therefore, the context information of the animation playback process of the target startup animation can be directly utilized when the exit animation is played (the context information of the animation playback process refers to the variables and data when the animation playback process runs), so that when the exit animation is played, the animation resources do not need to be initialized again.

In this way, the smoothness between the playback of the target startup animation and the playback of the exit animation is further improved.

At step S104, when the exit animation is completely played, execute an interruption to display an interface before the target startup animation is played.

The interruption includes an operation for returning to the interface before the target startup animation was played. For example, when the target startup animation is the startup animation of the application program, when the exit animation playback is complete, the operation of “back to the desktop” is performed to return to the desktop.

Because the execution time of interruption is longer, when the interruption is executed first and then the exit animation is played, the time between the playback of the target startup animation and the playback of the exit animation is longer, so that the playback connection of the target startup animation and the playback of the exit animation are not smooth. Furthermore, when the performance of the terminal is poor, the playback connection between the target startup animation and the playback of the exit animation is worse.

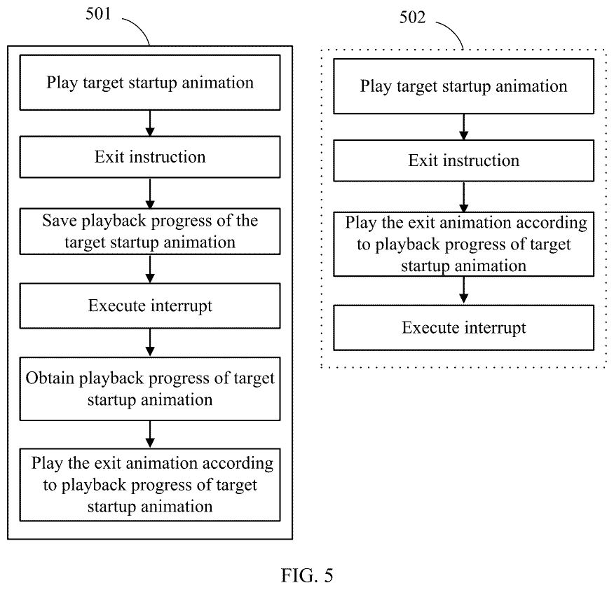

As shown in the picture 501 in FIG. 5, when the target startup animation is being played, an exit instruction is acquired. Then the playback progress of the target startup animation is saved, and an interrupt transaction is executed. And then, the playback progress of the target startup animation is acquired, and finally, the playback and exit animation is played according to the playback progress of the target startup animation.

In this embodiment, the exit animation is played first. When the exit animation is played, an interruption is executed, so that the playback of the target startup animation and the playback of the exit animation are seamlessly connected, and the connection between the playback of the target startup animation and the playback of the exit animation is improved. In this way, even in the terminal with poor performance, the playback of the target startup animation and the playback of the exit animation can still be smoothly connected, and the user experience is improved.

As shown in the picture 502 in FIG. 5, when the target startup animation is played, the exit instruction is acquired, the exit animation is played according to the playback progress of the target startup animation, and then the interrupt transaction is executed.

In some embodiments, the exit animation is played according to the playback progress of the target startup animation. The step of executing an interruption to display an interface before the target startup animation is played when the exit animation playback is completely played comprises:
acquiring a first startup sequence of an exit process corresponding to the exit animation and a second startup sequence of an interrupting process corresponding to the interruption, wherein the first startup sequence precedes the second startup sequence; and
starting the exit process and the interrupting process according to the playback progress of the target startup animation, the first startup sequence and the second startup sequence, so as to realize the step of executing the interruption when the exit animation is completely played.

In this embodiment, by presetting the first startup sequence of the exit process and the second startup sequence of interrupting the process (where the first startup sequence precedes the second startup sequence), and then the exit process and the interrupt process are started according to the first startup sequence and the second startup sequence, the step of executing the interruption when the exit animation is completely played can be realized.

When the playback code for the exit animation is in the animation playback process, the exit process is the animation playback process. Because the animation playback process is paused when the exit instruction against the target startup animation is acquired, the first startup sequence can be the sequence for continuing animation playback process.

The exit process corresponding to the exit animation refers to the playback process of the exit animation, and the interruption process of the interruption refers to the execution process of the interruption.

When the terminal monitors the target startup animation through the trigger function in the intermediate service, the steps of acquiring the playback progress of the target startup animation when the exit instruction for the target startup animation is detected and playing the exit animation according to the playback progress of the target startup animation comprise:
when the exit instruction for the target startup animation is detected through the trigger function, sending the exit instruction through the trigger function to a monitoring function in the animation playback process corresponding to the target starting animation; and
when the exit instruction is acquired through the monitoring function, utilizing the animation playback process corresponding to the target starting animation to acquire the playback progress of the target startup animation, and playing the exit animation according to the playback progress.

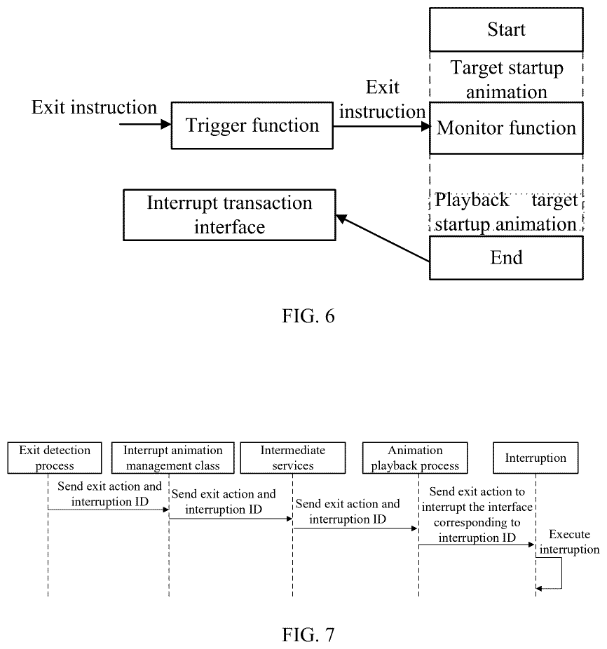

As shown in FIG. 6, after the exit instruction is detected by the trigger function, the exit instruction is sent to the monitoring function through the trigger function. When the exit instruction is acquired through the monitoring function, the animation playback process is used to play back the target startup animation, so as to realize the playback of the exit animation.

Optionally, when a trigger function is used to detect an exit instruction for the target startup animation, the step of the step of sending the exit instruction through the trigger function to the monitoring function in the animation playback process corresponding to the target starting animation when the exit instruction for the target startup animation is detected through the trigger function comprises: when the exit instruction for the target startup animation is detected through the trigger function, acquiring an interruption identifier (ID) corresponding to the target startup animation is acquired; and sending the exit instruction and the interruption ID through the trigger function to the monitoring function in the animation playback process corresponding to the target startup animation.

The step of when the exit animation is completely played, executing the interruption comprises: when the exit animation is completely played, acquiring the interruption ID from the monitoring function; and calling the interface corresponding to the interruption ID to execute the interruption.

In this embodiment, when an exit instruction (exit action) is acquired through a trigger function, the exit instruction and the interrupt transaction ID (IBreakAnimFinishedCallback callback) are sent to the monitoring function. At this time, the trigger function may be in the form of int breakAnim (int event, IBreakAnimFinishedCallback callback). The monitoring function (onBreak) acquires the exit instruction (exit action) and the interruption identifier (ID) can be in the form of onBreak (int event, IBreakAnimFinishedCallback callback).

The terminal then acquires the interruption ID through the monitoring function. Then, when the animation playback process is used, when the playback exit animation is completely played, the exit instruction is sent to the interface (onBreakAnimFinished) corresponding to the interrupt transaction ID through the animation playback process, and finally the interruption is executed according to the exit instruction through the interface corresponding to the interruption ID.

The exit detection process (such as a Home process) cannot be directly communicated with the animation playback process. Therefore, in this embodiment, an interruption animation management class and an intermediate service are established. When an exit instruction is acquired through the exit detection process, an exit instruction and an interrupt transaction ID are sent to the interruption animation management class, and then the exit action and the interruption ID are sent to the animation playback process by the interruption animation management class and the intermediate service. This enables cross-process communication between the exit detection process and the animation playback process.

As shown in FIG. 7, the exit action of the client is detected and the interruption ID is acquired through the exit detection process. The trigger function in the intermediate service is called through the interruption animation management class to acquire the exit action and the interrupting transaction ID from the exit detection process. That is, the exit action and the interruption ID are sent to the trigger function in the intermediate service by the interruption animation management class.

Then, through the trigger function in the intermediate service, the exit action and interruption ID are sent to the monitoring function in the animation playback process of the target startup animation. When the exit action and interruption ID are acquired through the monitoring function, the exit animation is played according to the playback progress of the target startup animation. In addition, when the exit animation is completely played, the interruption ID is acquired from the monitoring function, and the interface corresponding to the interruption ID is called, and the interruption is executed, so as to return to the interface before the target startup animation is played. That is, when the exit animation is completely played, the exit action is sent to the interface corresponding to the interruption ID to execute the interruption.

In the process of playing the target startup animation, when the exit instruction for the target startup animation is not acquired, the target startup animation can be deregistered, so that there is no need to monitor the target startup animation all the time. In other embodiments, the method further comprises following steps after the step of calling the trigger function in the intermediate services through the calling interface to monitor the target startup animation when registering the target startup animation is successful:
acquiring a playback completion instruction of the target startup animation through the interruption animation management class; and
through the calling interface, according to the playback completion instruction, calling a deregistration function in the intermediate service to deregister the target startup animation.

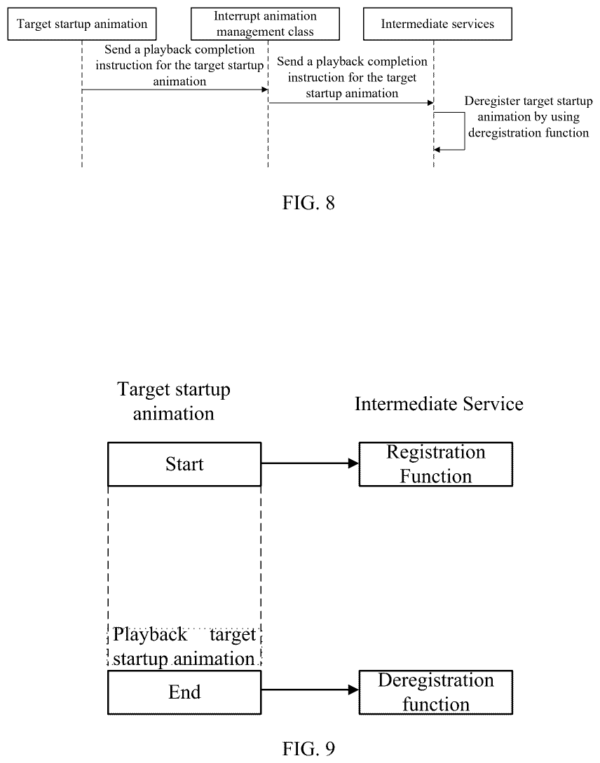

As shown in FIG. 8, when the playback of the target startup animation is completed, the deregistration function (removeBreakTarget) in the intermediate service is called by the calling interface of the interruption animation management class to deregister the target startup animation. The deregistration form can be void removeBreakTarget (IBreakable Target target).

When the playback completion instruction is acquired through the interruption animation management class, the playback completion instruction is sent to the intermediate service through the calling interface of the interruption animation management class, and then the target startup animation is deregistered through the deregistration function in the intermediate service.

In this embodiment, when the target startup animation starts to be played, the target startup animation is registered through the registration function in the intermediate service. When the target startup animation is completely played, the target startup animation is deregistered through the deregistration function in the intermediate service (as shown in FIG. 9), so that the target startup animation can be monitored when the target startup animation is played, and when the target startup animation is completely played, the monitoring of the target startup animation is ended.

In an embodiment of the present disclosure, the target startup animation that is being played is monitored. When an exit instruction for the target startup animation is detected, the playback progress of the target startup animation is acquired. Then, according to the playback progress of the target startup animation, the exit animation is played. When exit animation is completely played, an interruption is executed to display the interface before the target startup animation is played.

In an embodiment of the present disclosure, when the exit instruction of the target startup animation is monitored, the exit animation is first played according to the playback progress of the target startup animation, so that the playback of the target startup animation and the playback of the exit animation are seamlessly connected, and then the interruption is executed when the exit animation is completely played, so as to avoid that the playback of the startup animation and the playback of the exit animation are not smoothly connected due to the interruption when the exit instruction is acquired.

In order to facilitate the better implementation of the animation playback method provided in the embodiment of the present disclosure, an animation playback device is disclosed. The animation playback device can perform the above-mentioned animation playback method. The meaning of the noun is the same as in the above-mentioned animation playback method, and the specific implementation details can refer to the description in the method embodiment.

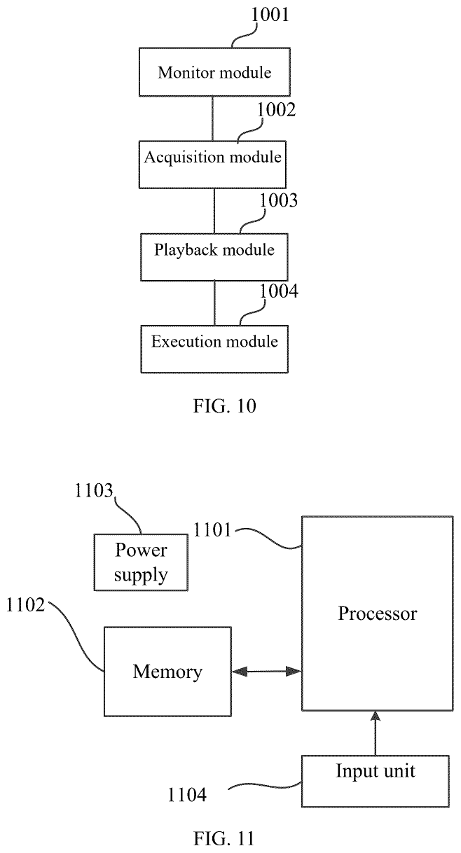

For example, as shown in FIG. 10, the animation playback device includes a monitor module 1001, an acquisition module 1002, a playback module 1003, and an execution module 1004.

The monitor module 1001 is configured to monitor a target startup animation that is being played.

The acquisition module 1002 is configured to acquire a playback progress of the target startup animation, when an exit instruction for the target startup animation is detected.

The playback module 1003 is configured to play an exit animation, according to the playback progress of the target startup animation.

The execution module 1004 is configured to execute an interruption to display an interface before the target startup animation is played, when the exit animation is completely played.

Optionally, the animation playback device further includes an instruction acquisition module 1002 configured to acquire an animation playback instruction and to activate an animation playback process according to the animation playback instruction to play the target startup animation. The animation playback process comprising a playback code for the target startup animation and a playback code for the exit animation. The playback module 1003 is configured to play an exit animation through the animation playback process according to the playback progress of the target startup animation.

Optionally, the playback module 1003 is configured to acquire a first startup sequence of an exit process corresponding to the exit animation and a second startup sequence of an interrupting process corresponding to the interruption. The first startup sequence precedes the second startup sequence. The playback module 1003 is configured to activate the exit process and the interrupting process according to the playback progress of the target startup animation, the first startup sequence and the second startup sequence, so as to realize the step of executing the interruption when the exit animation is completely played.

Optionally, the monitor module 1001 is configured to detect the target startup animation, and register the target startup animation to monitor the target startup animation, when the target startup animation is detected to be being played.

Optionally, the monitor module 1001 is configured to acquire the target startup animation through an interruption management class, when the target startup animation is detected to be being playing, wherein the interruption animation management class comprises a calling interface of an intermediate service. The monitor module 1001 is configured to call a registration function in the intermediate service to register the target startup animation through the calling interface, and call a trigger function in the intermediate services through the calling interface to monitor the target startup animation when registering the target startup animation is successful.

Optionally, the acquisition module 1002 is configured to, when the exit instruction for the target startup animation is detected through the trigger function, send the exit instruction through the trigger function to a monitoring function in the animation playback process corresponding to the target starting animation. The playback module 1003 is configured to, when the exit instruction is acquired through the monitoring function, utilize the animation playback process corresponding to the target starting animation to acquire the playback progress of the target startup animation, and play the exit animation according to the playback progress.

Optionally, when the exit instruction for the target startup animation is detected through the trigger function, the instruction acquisition module 1002 is configured to acquire an interruption identifier (ID) corresponding to the target startup animation, and send the exit instruction and the interruption ID through the trigger function to the monitoring function in the animation playback process corresponding to the target startup animation. The execution module 1004 is configured to acquire the interruption ID from the monitoring function when the exit animation is completely played, and call the interface corresponding to the interruption ID to execute the interruption.

Optionally, the animation playback device further includes a creation module configured to acquire the registration function and the trigger function, and create the intermediate service according to the registration function and the trigger function. The creation module is also configured to according to the calling interface of the intermediate service, create the interruption animation management class.

Optionally, the animation playback device further includes a deregister module configured to acquire a playback completion instruction of the target startup animation through the interruption animation management class. The deregister module is configured to, according to the playback completion instruction, call a deregistration function in the intermediate service to deregister the target startup animation through the calling interface.

Optionally, the exit animation is the same type of animation as the target start animation.

Correspondingly, the playback module 1003 is configured to, according to the playback progress of the target startup animation, play back the target startup animation to play the exit animation.

Optionally, the exit animation is the different from the target start animation.

Correspondingly, the playback module 1003 is configured to acquire the exit animation, determine a starting playback position of the exit animation according to the playback progress of the target start-up animation, and play the exit animation from the starting playback position.

Correspondingly, the playback module 1003 is configured to determine the exit animation corresponding to the exit action, and play the exit animation corresponding to the exit action according to the playback progress of the target startup animation.

Each module can be realized as an independent entity, or can be arbitrarily combined, and realized as the same or several entities, and the specific embodiment of each module and the corresponding beneficial effect can refer to the previous method embodiment, and will not be repeated herein.

The embodiment of the present disclosure also provides an electronic device, which may be a server or a terminal, etc., as shown in FIG. 11, which illustrates a schematic diagram of the electronic device according to an embodiment of the present disclosure.

The electronic device includes a processor 1101 having one or more processing cores, a memory 1102 having one or more computer-readable storage media, a power supply 1103, and an input unit 1104. Those skilled in the art can understand that the structure of the electronic device illustrated in FIG. 11 does not constitute a limitation of the electronic device, and may include more or fewer parts than illustrated, or the combination of certain parts, or different parts arrangement.

The processor 1101 is a control center of the electronic device, which utilizes various interfaces and lines to connect various parts of the entire electronic device, and performs various functions and processes data of the electronic device by running or executing computer programs and/or modules stored in the memory 1102 and calling the data stored in the memory 1102. Optionally, the processor 1101 may include one or more processing cores. Preferably, the processor 1101 can integrate an application processor and a modem processor, where the application processor mainly processes the operating system, the user interface and the application and the like, and the modem processor mainly processes wireless communication. Understandably, the aforementioned modem processor can also be left unintegrated into the processor 1101.

The memory 1102 can be used to store computer programs and modules, and the processor 1101 performs various functional applications and data processing by running computer programs and modules stored in memory 1102. The memory 1102 may mainly comprise a storage program area and a storage data area, wherein the storage program area can store the operating system, a computer program required for at least one function (such as a sound playback function, an image playback function). The storage data area can store data created based on the use of electronic devices. In addition, memory 1102 can include high-speed random access memory and can also include non-volatile memory, such as at least one disk storage device, flash memory device, or other volatile solid-state memory device. Correspondingly, memory 1102 may also include a memory controller to provide access from the processor 1101 to memory 1102.

The electronic device also comprises the power supply 1103 that supplies power to each component. Preferably, the power supply 1103 can be logically connected with the processor 1101 through a power management system, so that functions such as managing charging, discharging, and power consumption management are realized through the power management system. The power supply 1103 can also include any component such as one or more DC or AC power sources, recharging systems, power fault detection circuits, power converters or inverters, and power status indicators.

The electronic device may also include an input unit 1104 that can be used to receive input numeric or character information and to generate keyboard, mouse, joystick, optical, or trackball signal input related to user settings and function control.

Although not shown, the electronic device may also include a display unit which will not be repeated here. Specifically, in this embodiment, the processor 1101 in the electronic device will load the executable file corresponding to the process of one or more computer programs into the memory 1102 according to the following instructions. The processor 1101 will run the computer program stored in the memory 1102 to perform operations comprising:
monitoring a target startup animation that is being played;
when an exit instruction for the target startup animation is detected, acquiring a playback progress of the target startup animation;
according to the playback progress of the target startup animation, playing an exit animation; and
when the exit animation is completely played, executing an interruption to display an interface before the target startup animation is played.

The specific embodiment of each of the above operations and the corresponding beneficial effects can be found in the detailed description of the animation playback method above, and will not be repeated here.

A person skilled in the art may understand that all or part of the steps in the various methods of the above embodiments may be completed by a computer program or by controlling the relevant hardware through a computer program, and the computer program may be stored in a computer-readable storage medium and loaded and executed by a processor.

For this purpose, the embodiment of the present disclosure provides a computer-readable storage medium storing computer instructions executable by a processor to perform steps in any of the animation playback methods provided in the embodiment of the present disclosure. For example, the computer instructions can be executed to perform the following steps:
monitoring a target startup animation that is being played;
when an exit instruction for the target startup animation is detected, acquiring a playback progress of the target startup animation;
according to the playback progress of the target startup animation, playing an exit animation; and
when the exit animation is completely played, executing an interruption to display an interface before the target startup animation is played.

The specific embodiment of each of the above operations and the corresponding beneficial effects can be referred to in the previous embodiments, and will not be repeated here.

The computer readable storage medium may include a read only memory (ROM), a random access memory (RAM), disk or optical disc, etc.

Because the computer program stored in the computer-readable storage medium can perform the steps in any of the animation playback methods provided in the embodiments of the present disclosure, the advantageous effects that can be achieved by any of the animation playback methods provided in the embodiments of the present disclosure can be realized. Please refer to the previous embodiments for details, and will not be repeated herein.

Pursuant to one aspect of the present disclosure, a computer program product or computer program is provided that comprises computer instructions stored in a computer-readable storage medium. The processor of a computer device reads the computer instruction from a computer-readable storage medium, and the processor executes the computer instruction so that the computer device performs the animation playback method.

The above is a detailed introduction to an animation playback method, an apparatus, an electronic device, and a computer-readable storage media provided by the embodiment of the present disclosure, and the principle and embodiment of the present disclosure are described in this article by applying specific examples, and the description of the above embodiment is only used to help understand the method and the core idea of the present disclosure. At the same time. for those skilled in the art. there will be changes in the specific embodiment and scope of application according to the idea of the present disclosure, and in summary, the contents of this specification should not be construed as a restriction on the present disclosure.

1. A method of playing animations, comprising:
monitoring a target startup animation that is being played;
when an exit instruction for the target startup animation is detected, acquiring a playback progress of the target startup animation;
according to the playback progress of the target startup animation, playing an exit animation; and
when the exit animation is completely played, executing an interruption to display an interface before the target startup animation is played.

2. The method of claim 1, further comprising following steps before acquiring the playback progress of the target startup animation:
acquiring an animation playback instruction; and
activating an animation playback process according to the animation playback instruction to play the target startup animation, and the animation playback process comprises a playback code for the target startup animation and a playback code for the exit animation; and
wherein the step of playing an exit animation according to the playback progress of the target startup animation comprises:
playing an exit animation through the animation playback process according to the playback progress of the target startup animation.

3. The method of claim 1, wherein the steps of playing an exit animation according to the playback progress of the target startup animation and executing an interruption to display an interface before the target startup animation is played when the exit animation is completely played comprise:
acquiring a first startup sequence of an exit process corresponding to the exit animation and a second startup sequence of an interrupting process corresponding to the interruption, wherein the first startup sequence precedes the second startup sequence; and
starting the exit process and the interrupting process according to the playback progress of the target startup animation, the first startup sequence and the second startup sequence, so as to realize the step of executing the interruption when the exit animation is completely played.

4. The method of claim 1, wherein the step of monitoring a target startup animation that is being played comprises:
detecting the target startup animation; and
when the target startup animation is detected to be being played, registering the target startup animation to monitor the target startup animation.

5. The method of claim 4, wherein the step of registering the target startup animation to monitor the target startup animation when the target startup animation is detected to be being played comprises:
when the target startup animation is detected to be being playing, acquiring the target startup animation through an interruption management class, wherein the interruption animation management class comprises an calling interface of an intermediate service;
through the calling interface, calling a registration function in the intermediate service to register the target startup animation; and
when registering the target startup animation is successful, calling a trigger function in the intermediate services through the calling interface to monitor the target startup animation.

6. The method of claim 5, wherein the steps of acquiring the playback progress of the target startup animation when the exit instruction for the target startup animation is detected and playing the exit animation according to the playback progress of the target startup animation comprise:
when the exit instruction for the target startup animation is detected through the trigger function, sending the exit instruction through the trigger function to a monitoring function in the animation playback process corresponding to the target starting animation; and
when the exit instruction is acquired through the monitoring function, utilizing the animation playback process corresponding to the target starting animation to acquire the playback progress of the target startup animation, and playing the exit animation according to the playback progress.

7. The method of claim 6, wherein the step of sending the exit instruction through the trigger function to the monitoring function in the animation playback process corresponding to the target starting animation when the exit instruction for the target startup animation is detected through the trigger function comprises:
when the exit instruction for the target startup animation is detected through the trigger function, acquiring an interruption identifier (ID) corresponding to the target startup animation is acquired; and
sending the exit instruction and the interruption ID through the trigger function to the monitoring function in the animation playback process corresponding to the target startup animation;
wherein the step of when the exit animation is completely played, executing the interruption comprises:
when the exit animation is completely played, acquiring the interruption ID from the monitoring function; and
calling the interface corresponding to the interruption ID to execute the interruption.

8. The method of claim 5, further comprising following steps when the target startup animation is detected to be being playing and before acquiring the target startup animation by interrupting the animation management class:
acquiring the registration function and the trigger function, and creating the intermediate service according to the registration function and the trigger function; and
according to the calling interface of the intermediate service, creating the interruption animation management class.

9. The method of claim 5, further comprising following steps after the step of calling the trigger function in the intermediate services through the calling interface to monitor the target startup animation when registering the target startup animation is successful:
acquiring a playback completion instruction of the target startup animation through the interruption animation management class; and
through the calling interface, according to the playback completion instruction, calling a deregister function in the intermediate service to deregister the target startup animation.

10. The method of claim 1, wherein the exit animation is an animation of the same type as the target startup animation; and the step of playing the exit animation, according to the playback progress of the target startup animation comprises:
according to the playback progress of the target startup animation, playing back the target startup animation to play the exit animation.

11. The method of claim 1, wherein the exit animation and the target startup animation are different types of animations; and the step of playing the exit animation, according to the playback progress of the target startup animation comprises:
getting the exit animation;
determining a starting playback position of the exit animation according to the playback progress of the target start-up animation; and
from the starting playback position, playing the exit animation.

12. The method of claim 1, wherein the exit instruction comprises an exit action; and the step of playing the exit animation according to the playback progress of the target startup animation comprises:
determining the exit animation corresponding to the exit action; and
according to the playback progress of the target startup animation, playing the exit animation corresponding to the exit action.

13-18. (canceled)

19. An electronic device, comprising a processor and a memory storing computer instructions executable by the processor to perform operations comprising:
monitoring a target startup animation that is being played;
when an exit instruction for the target startup animation is detected, acquiring a playback progress of the target startup animation;
according to the playback progress of the target startup animation, playing an exit animation; and
when the exit animation is completely played, executing an interruption to display an interface before the target startup animation is played.

20. A non-transitory computer-readable storage medium storing computer instructions executable by a processor to perform operations comprising:
monitoring a target startup animation that is being played;
when an exit instruction for the target startup animation is detected, acquiring a playback progress of the target startup animation;
according to the playback progress of the target startup animation, playing an exit animation; and
when the exit animation is completely played, executing an interruption to display an interface before the target startup animation is played.

21. The electronic device of claim 19, wherein the operations further comprise:
acquiring an animation playback instruction; and
activating an animation playback process according to the animation playback instruction to play the target startup animation, and the animation playback process comprises a playback code for the target startup animation and a playback code for the exit animation; and
wherein the operation of playing an exit animation according to the playback progress of the target startup animation comprises:
playing an exit animation through the animation playback process according to the playback progress of the target startup animation.

22. The electronic device of claim 19, wherein the operations of playing an exit animation according to the playback progress of the target startup animation and executing an interruption to display an interface before the target startup animation is played when the exit animation is completely played comprise:
acquiring a first startup sequence of an exit process corresponding to the exit animation and a second startup sequence of an interrupting process corresponding to the interruption, wherein the first startup sequence precedes the second startup sequence; and
starting the exit process and the interrupting process according to the playback progress of the target startup animation, the first startup sequence and the second startup sequence, so as to realize the operation of executing the interruption when the exit animation is completely played.

23. The electronic device of claim 19, wherein the operation of monitoring a target startup animation that is being played comprises:
detecting the target startup animation; and
when the target startup animation is detected to be being played, registering the target startup animation to monitor the target startup animation.

24. The electronic device of claim 19, wherein the operation of registering the target startup animation to monitor the target startup animation when the target startup animation is detected to be being played comprises:
when the target startup animation is detected to be being playing, acquiring the target startup animation through an interruption management class, wherein the interruption animation management class comprises a calling interface of an intermediate service;
through the calling interface, calling a registration function in the intermediate service to register the target startup animation; and
when registering the target startup animation is successful, calling a trigger function in the intermediate services through the calling interface to monitor the target startup animation.

25. The electronic device of claim 24, wherein the operations of acquiring the playback progress of the target startup animation when the exit instruction for the target startup animation is detected and playing the exit animation according to the playback progress of the target startup animation comprise:
when the exit instruction for the target startup animation is detected through the trigger function, sending the exit instruction through the trigger function to a monitoring function in the animation playback process corresponding to the target starting animation; and
when the exit instruction is acquired through the monitoring function, utilizing the animation playback process corresponding to the target starting animation to acquire the playback progress of the target startup animation, and playing the exit animation according to the playback progress.
